(19) United States
(12) Patent Application Publication
(10) Pub. No.: US 2008/0246784 A1
(43) Pub. Date: Oct. 9, 2008

(54) Display device

(75) Inventor: Ikuko Mori, Chiba (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 12/078,614

(22) Filed: Apr. 2, 2008

(30) Foreign Application Priority Data
Apr. 5, 2007 (JP) 2007-099057

(51) Int. Cl. G09G 5/10

(52) U.S. Cl. 345/690

(57) ABSTRACT

The present invention improves, in a display device to which normal display data and interpolation data are inputted from the outside, the moving image performance by applying overdrive processing to both of a bright frame and a dark frame. The display device includes a display panel having a plurality of sub pixels, and a driver for outputting a video voltage corresponding to the display data to the respective sub pixels. The display data inputted from the external system is constituted of normal display data and interpolation display data inserted between the normal display data. The signal generation circuit includes an overdrive circuit for applying overdrive processing to the normal display data and the interpolation display data inputted from the external system, and a gray scale conversion circuit for converting the gradation of display data applied overdrive by the overdrive circuit. Assuming two continuous frame periods as one unit and assuming the display data inputted from the external system within the two continuous frame periods as first display data and second display data, when the display data inputted from the external system is of an intermediate gray scale, gray scale based on the second display data after conversion is set lower than gray scale based on the first display data after conversion.

The present application claims priority from Japanese application JP2007-099057 filed on Apr. 5, 2007, the content of which is hereby incorporated by reference into this application.

### BACKGROUND OF THE INVENTION

1. Field of the Invention

The present invention relates to a hold-type display device such as a liquid crystal display device, an organic EL (Electro Luminescence) display or an LCOS (Liquid Crystal On Silicon) display, and more particularly to a display device suitable for moving-image display.

2. Description of the Related Art

In classifying a display device from a viewpoint of moving-image display particularly, the display device is roughly classified into an impulse-response-type display device and a hold-response-type display device. The impulse-response-type display device is a display device of a type in which a brightness response is lowered immediately after scanning in the same manner as light retention characteristic of a cathode ray tube, and the hold-response-type display device is a display device of a type which holds brightness based on display data until next scanning is performed as in the case of a liquid crystal display device.

With respect to characteristics of the hold-response-type display device, although the display device can acquire favorable display quality with no flickers in case of a still image, so-called moving-image blurring in which surrounding of a moving object is blurred arises in case of a moving image thus giving rise to a drawback that display quality is remarkably lowered.

Such moving-image blurring is generated attributed to a so-called retina image retention in which a viewer interpolates display images before and after the movement of a display image in which brightness is held when a line of sight of the viewer moves along with the movement of the object. Accordingly, even when a response speed of the display device is increased as fast as possible, it is impossible to completely eliminate moving-image blurring.

As a technique for overcoming such a drawback, a method which approximates the hold-response-type display device to the impulse-response-type display device by updating a display image with shorter frequencies or by temporarily canceling the retina image retention with the insertion of a black screen or the like is effectively used.

As the method for approximating the hold-response-type display device to the impulse-response-type display device, there has been known a method which displays gray scales required by an external system in a pseudo manner by performing display with the changeover of the gray scale between a predetermined gray scale and a minimum gray scale when the gray scale required by the external system is on a low-gray-scale side (hereinafter, referred to as Flexible Black Insertion (FBI) drive method) (see JP-A-2006-343706 (corresponding US patent application US2006/0256141A) (patent document 1)).

In the FBI drive method, the gray scales required by the external system are displayed in a pseudo manner by displaying a plurality of gray scales within one frame in each sub pixel. Further, when the gray scale required by the external system is an intermediate low gray scale, at least one gray scale out of the plurality of gray scales is set as the minimum gray scale (minimum brightness), while when the gray scale required by the external system is an intermediate high gray scale, at least one other gray scale out of the plurality of gray scales is set as the maximum gray scale (maximum brightness).

That is, when the gray scale required by the external system is on a low gray-scale side, the gray scale required by the external system is displayed in a pseudo manner with the display which changes over the gray scale between the predetermined gray scale and the minimum gray scale.

On the other hand, when the gray scale required by the external system is on a high gray-scale side, the gray scale required by the external system is displayed in a pseudo manner with the display which changes over the gray scale between the predetermined gray scale and the maximum gray scale.

### SUMMARY OF THE INVENTION

FIG. 6A to FIG. 6D are views for explaining a conventional FBI drive method. Here, FIG. 6A to FIG. 6D are views showing a state in which a gray object is moved in the direction indicated by an arrow A. In FIG. 6A to FIG. 6D, symbols FMD, FRD express the brightness of sub pixels on one display line within one frame, and an arrow indicated by a broken line shows a lapse of time.

As shown in FIG. 6A, display data of a 60 Hz frame is inputted to a liquid crystal display module from the outside, and the display data of this 60 Hz frame is stored in a frame memory. By reading the display data of the 60 Hz frame stored in the frame memory twice within one frame, as shown in FIG. 6B, display data of a 120 Hz frame which is twice as large as the 60 Hz frame is formed.

Overdrive (OD) processing is applied to the display data as shown in FIG. 6C. Here, in FIG. 6C and FIG. 6D, sub pixels corresponding to the display data to which the overdrive processing is applied are illustrated with a bold-line frame.

Finally, as shown in FIG. 6D, with FBI processing, starting display data of the 120 Hz frame is converted into display data for bright frame and the next display data of 120 Hz frame is converted into display data for dark frame.

Due to such processing, it is possible to acquire impulse driving of black insertion data of 50% with a low gray scale thus improving image quality of a moving image. In this case, an OD coefficient is set to “0” in the dark frame thus executing the overdrive processing for improving the image quality of the moving image only in the bright frame.

As described above, conventionally, for forming the display data having frequency twice as large as the frequency of the inputted display data of 60 Hz frame, the frame memory becomes necessary. Here, as a technique for reducing a cost, the reduction of the frame memory is effective.

To reduce the frame memory and, at the same time, to improve the moving image performance, it is necessary to convert the display data inputted from the outside into the display data of 120 Hz frame twice as large as the 60 Hz frame. Further, at the same time, the 120 Hz display data may be constituted of normal display data and vector interpolation data inserted between the normal display data.

However, in the conventional FBI processing, the overdrive processing is applied only to the bright frame and hence, when the display data inputted from the outside is constituted of normal display data and vector interpolation data inserted between the normal display data, a waving phenomenon is generated in a brightness cross-sectional profile thus giving rise to a drawback that the moving image performance is lowered.

The present invention has been made to overcome the above-mentioned drawback of the related art and it is an object of the present invention to, in a display device to which normal display data and interpolation data inserted between the normal display data are inputted from the outside, improve the moving image performance by applying overdrive processing to both of a bright frame and a dark frame.

The above-mentioned and other object and novel features of the present invention will become apparent from the description of this specification and attached drawings.

To briefly explain the summary of typical inventions among the invention disclosed in this specification, they are as follows.

In a display device which includes: a display panel having a plurality of sub pixels; a signal generation circuit for generating a control signal for driving the display panel in response to an inputted signal from the external system; and a driver for outputting a video voltage corresponding to the display data to the respective sub pixels, the display data inputted from the external system is constituted of normal display data and interpolation display data inserted between the normal display data and generated based on the normal display data by interpolation, the signal generation circuit includes an overdrive circuit for applying overdrive processing to the normal display data and the interpolation display data inputted from the external system, and a gray scale conversion circuit for converting the gradation of display data applied overdrive by the overdrive circuit, assuming two continuous frame periods as one unit and assuming the display data inputted from the external system within the two continuous frame periods as first display data and second display data, when the display data inputted from the external system is of an intermediate gray scale, gray scale based on the second display data after conversion is set lower than gray scale based on the first display data after conversion.

Further, in a display device including a display panel which has a plurality of sub pixels and displaying an image on the display panel by setting an interval of 120 Hz as one frame period, the display device includes: an overdrive circuit for correcting image information of each frame based on the image information of the frame immediately before the present frame; and a brightness conversion circuit which forms bright frame and dark frame alternately with time by performing processing for forming bright frame by increasing brightness of the image information of each frame and processing for forming dark frame by decreasing the brightness of the image information of each frame.

To briefly explain advantageous effects obtained by typical inventions among the invention described in this specification, they are as follows.

According to the present invention, in the display device to which the normal display data and the interpolation data inserted between the normal display data are inputted from the outside, it is possible to improve the moving image performance by applying the overdrive processing to both of the bright frame and the dark frame.

### BRIEF EXPLANATION OF THE DRAWINGS

FIG. 1 is a block diagram showing the schematic constitution of a liquid crystal display module of an embodiment of the present invention;

FIG. 2 is a block diagram showing the schematic constitution of a display data conversion circuit shown in FIG. 1;

FIG. 3H to FIG. 3J are views for explaining an FBI drive method of the liquid crystal display module of the embodiment of the present invention;

FIG. 4 is a view showing the conversion characteristic from the input display data into display data for bright frame and the conversion characteristic from the input display data into display data for dark frame in the liquid crystal display module of the embodiment of the present invention;

FIG. 5 is a view showing another example a look-up table shown in FIG. 2;

FIG. 6A to FIG. 6D are views for explaining a conventional FBI drive method; and

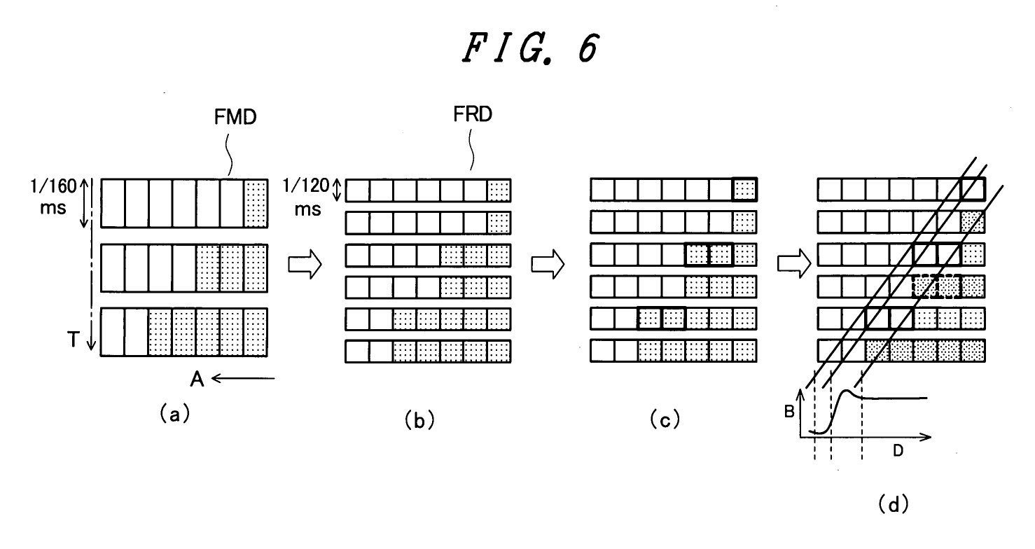

FIG. 7E to FIG. 7G are views for explaining an FBI drive method when over drive processing is not applied to the dark frame.

### DESCRIPTION OF THE PREFERRED EMBODIMENT

Hereinafter, an embodiment of the present invention is explained in detail in conjunction with drawings.

Here, in all drawings for explaining the embodiment, parts having identical functions are given same numerals and their repeated explanation is omitted.

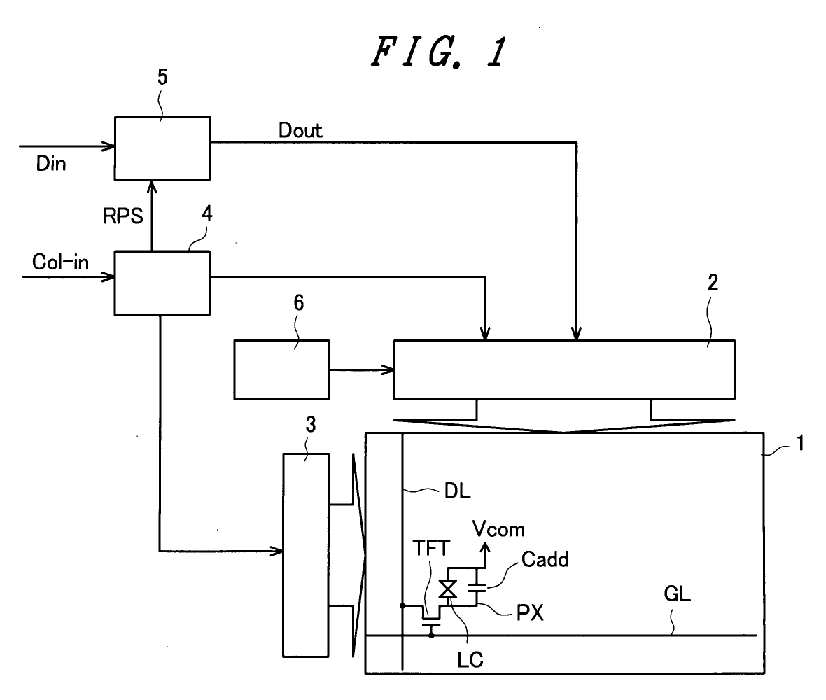

FIG. 1 is a block diagram showing the schematic constitution of a liquid crystal display module of an embodiment of the present invention.

The liquid crystal display module of this embodiment includes a liquid crystal display panel 1, a drain driver 2, a gate driver 3, a timing generation circuit 4, a display data conversion circuit 5, and a gray-scale-voltage generation circuit 6.

The drain driver 2 and the gate driver 3 are arranged on a peripheral portion of the liquid crystal display panel 1. The gate driver 3 is constituted of a plurality of gate drivers IC arranged on one side of the liquid crystal display panel 1. Further, the drain driver 2 is constituted of a plurality of drain drivers IC arranged on another side of the liquid crystal display panel 1.

The timing generation circuit 4 drives the drain driver 2 and the gate driver 3 based on a vertical synchronizing signal (Vsync) defining one frame period (a period displaying one screen), a horizontal synchronizing signal (Hsync) defining one horizontal scanning period (a period displaying one line), a display timing signal (DISP) defining an effective period of display data, and a reference clock signal (DCLK) generated in synchronism with the display data which are inputted from an external system (for example, a television receiver set, a personal computer, a mobile phone).

In FIG. 1, symbol DL indicates video lines (also referred to as drain lines or source lines), symbol GL indicates scanning lines (also referred to as gate lines), symbol PX indicates pixel electrodes of respective colors (red, green, blue), symbol CT indicates a counter electrode (also referred to as a common electrode), symbol LC indicates a liquid crystal capacitance equivalently indicating a liquid crystal layer, and symbol Cadd indicates a holding capacitance formed between the counter electrode (CT) and the pixel electrode (PX).

In the liquid crystal display panel 1 of this embodiment, the drain electrodes of thin film transistors (TFT) of the respective sub pixels arranged in the column direction are respectively connected to the video line (DL), and the respective video lines (DL) are connected to the drain driver 2 which supplies a video voltage corresponding to the display data to the sub pixels arranged in the column direction.

Further, the gate electrodes of the thin film transistors (TFT) of the respective sub pixels arranged in the row direction are respectively connected to the scanning line (GL), and the respective scanning lines (GL) are connected to the gate driver 3 which supplies a scanning voltage (a positive or negative bias voltage) to the gates of the thin film transistors (TFT) for one horizontal scanning time.

The gate driver 3 supplies the scanning voltage to the scanning lines (GL) based on a control by the timing generation circuit 4. Further, the drain driver 2 supplies a video voltage (that is, a voltage corresponding to the display data among gray-scale voltages generated by the gray-scale-voltage generation circuit 6) to the video lines (DL) in response to a signal from the timing generation circuit 4.

In displaying an image on the liquid crystal display panel 1, the gate driver 3 selects the scanning lines (GL) by sequentially supplying a selection scanning voltage to the scanning lines (GL) from above to below (or from below to above). On the other hand, during a selection period of a scanning line (GL), the drain driver 2 supplies a video voltage corresponding to the display data to the video lines (DL) and applies the video voltage to the pixel electrodes (PX).

The voltage supplied to the video lines (DL) is applied to the pixel electrodes (PX) via the thin film transistors (TFT) and, eventually, a charge is charged in the holding capacitance (Cadd) and the liquid crystal capacitance (LC) so as to control liquid crystal molecules thus displaying an image.

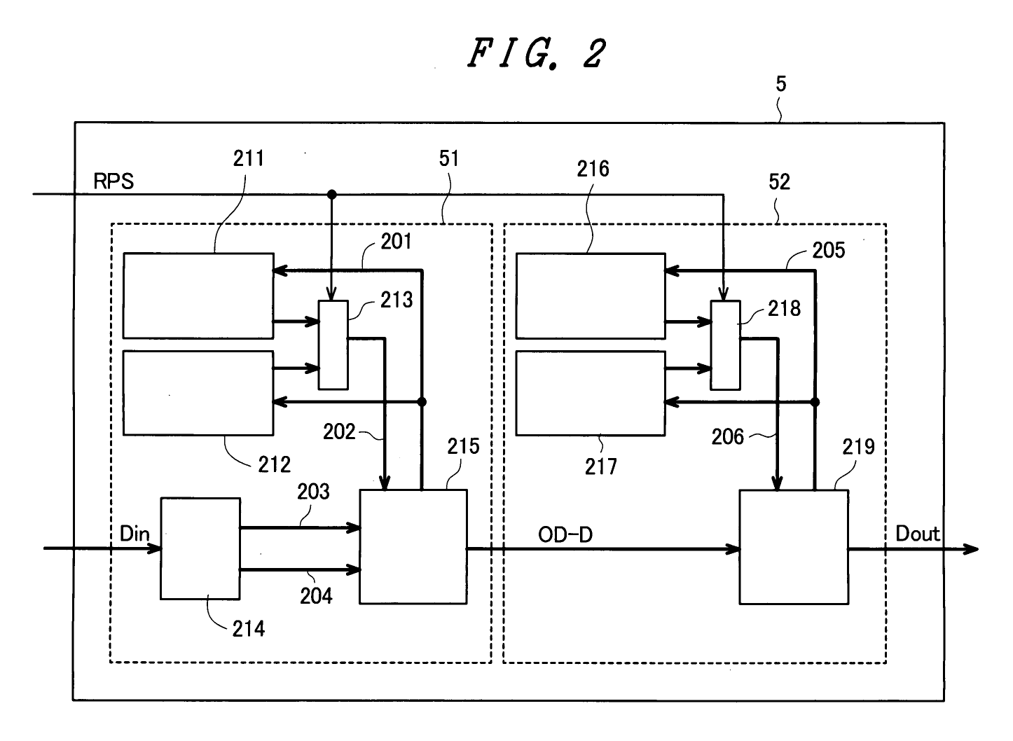

FIG. 2 is a block diagram showing the schematic constitution of the display data conversion circuit 5 shown in FIG. 1. In FIG. 2, numeral 51 indicates an overdrive processing circuit, and numeral 52 indicates an FBI processing circuit.

The overdrive processing 51 is constituted of a look-up table 211 for storing an overdrive correction quantity for bright frame, a look-up table 212 for storing an overdrive correction quantity for dark frame, a selector 213, a memory 214, and an arithmetic operation circuit 215. Here, the bright frame and the dark frame are explained later.

In this embodiment, normal display data and interpolation display data inserted between the normal display data and generated based on the normal display data by vector interpolation are inputted to the display data conversion circuit 51 from the outside for every 120 Hz frame. The display data inputted from the outside for every 120 Hz frame is sequentially stored in the memory 214.

Display data 203 immediately before a present frame read from the memory 214 and the display data 204 of the present frame are inputted to the arithmetic operation circuit 215. The arithmetic operation circuit 215 compares the display data 203 and the display data 204 with each other, generates a read address 201, and reads overdrive correction quantities from the look-up table 211 and the look-up table 212.

With respect to the overdrive correction quantity read from the look-up table 211 and the overdrive correction quantity read from the look-up table 212, either one of the overdrive correction quantities 202 is inputted to the arithmetic operation circuit 215 by the selector 213 controlled in response to a changeover signal (RPS). The arithmetic operation circuit 215 applies overdrive processing to the display data 204 of the present frame by adding the overdrive correction quantity 202 to the display data 204 or subtracting the overdrive correction quantity 202 from the display data 204.

The FBI processing circuit 52 is constituted of a look-up table 216 for storing an FBI predetermined value for bright frame, a look-up table 217 for storing an FBI predetermined value for dark frame, a selector 218 and an arithmetic operation circuit 219.

As described above, in this embodiment, the normal display data and the interpolation display data are inputted to the display data conversion circuit 5 from the outside for every 120 Hz frame. Here, by setting two continuous frame periods as one unit, the display data inputted firstly to the display data conversion circuit 5 from an external system within the two continuous frame periods is assumed as first display data, and the display data inputted secondly to the display data conversion circuit 5 from the external system within the two continuous frame periods is assumed as second display data, wherein the first display data constitutes the display data for bright frame, and second display data constitutes the display data for dark frame.

The display data outputted from the arithmetic operation circuit 215 is inputted to an arithmetic operation circuit 219. The arithmetic operation circuit 219 reads an FBI predetermined value 206 corresponding to the display data outputted from the arithmetic operation circuit 215 from the look-up table 216 and the look-up table 217. With respect to the FBI predetermined value read from the look-up table 216 and the FBI predetermined value read from the look-up table 217, either one of the FBI predetermined values is inputted to the arithmetic operation circuit 219 by the selector 218 controlled in response to a changeover signal (RPS), and is converted into the display data for bright frame or the display data for dark frame.

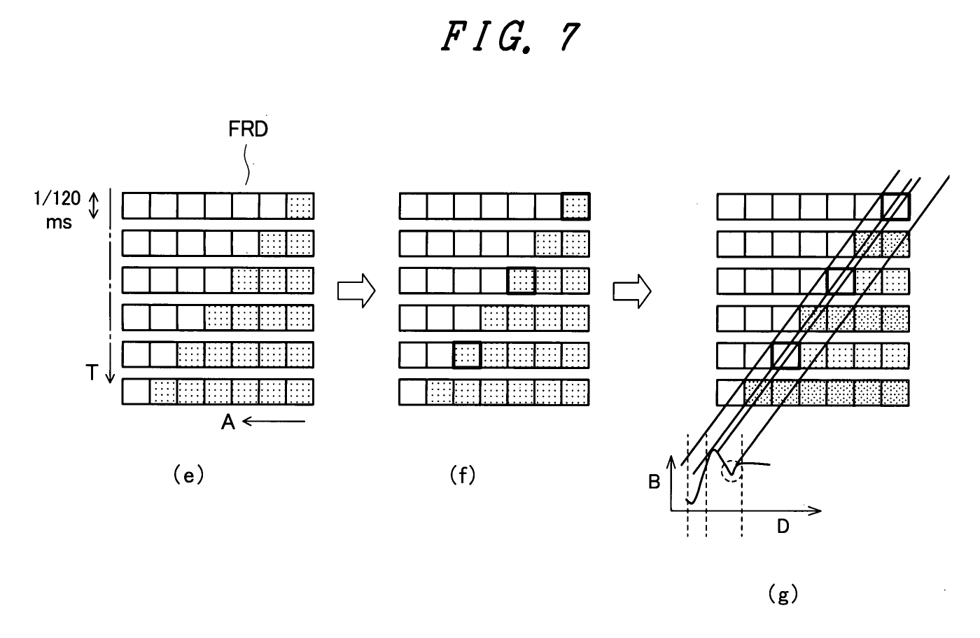

FIG. 7E to FIG. 7G are views for explaining an FBI drive method performed when overdrive processing is not applied to the dark frame in inputting the normal display data and the interpolation display data for every 120 Hz frame from the outside. Here, FIG. 7E to FIG. 7G show a state in which a gray object is moved in the direction indicated by an arrow A. In FIG. 7E to FIG. 7G, symbol FRD indicates brightnesses of sub pixels on 1 display line within one frame, and an arrow indicated by a broken line shows a lapse of time.

As shown in FIG. 7E, the normal display data and the interpolation display data are inputted to the liquid crystal display module from the outside for every 120 Hz frame period having a cycle twice as large as the 60 Hz frame. As described above, the display data firstly inputted to the liquid crystal display module is set as the first display data, and the display data secondly inputted to the liquid crystal display module is set as the second display data, wherein the first display data constitutes the display data for bright frame, and second display data constitutes the display data for dark frame.

As shown in FIG. 7F, the overdrive (OD) processing is applied to the first display data. Here, in FIG. 7F and FIG. 7G, the sub pixels corresponding to the display data to which the overdrive processing is applied are indicated with a bold-line frame. Further, the overdrive (OD) processing is applied only to the first display data for bright frame.

Next, the FBI processing is executed. However, in the FIB processing shown in FIG. 7F and FIG. 7G, as indicated by a brightness cross-sectional profile shown in FIG. 7G, due to the overdrive processing in the bright frame, a waving phenomenon in which the brightness of a pattern edge is increased and the brightness of a neighboring portion of the pattern edge (a portion surrounded by a dotted-line circle in the drawing) is lowered since the overdrive processing is not applied to the neighboring portion arises thus deteriorating the moving image performance. In the brightness cross-sectional profile shown in FIG. 7G, the distance is taken on an axis of abscissas and the brightness is taken on an axis of ordinates.

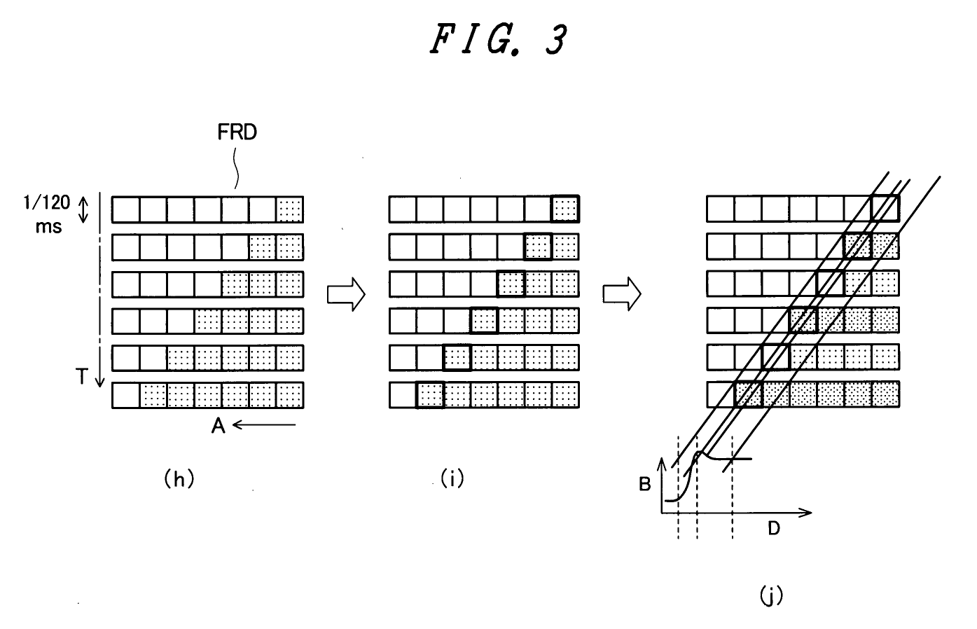

FIG. 3H to FIG. 3J are views for explaining the FBI drive method of this embodiment. Here, FIG. 3H to FIG. 3J show a state in which a gray object is moved in the direction indicated by an arrow A. In FIG. 3H to FIG. 3J, symbol FRD indicates brightnesses of sub pixels on one display line within one frame, and an arrow indicated by a broken line shows a lapse of time.

Also in this embodiment, as shown in FIG. 3H, the normal display data and the interpolation display data are inputted to a liquid crystal display module from the outside for every 120 Hz frame period having a cycle twice as large as the 60 Hz frame period.

Then, as shown in FIG. 3I, the overdrive (OD) processing is applied to both of first display data and second display data. In FIG. 3, the sub pixels corresponding to the display data to which the overdrive processing is applied are indicated with a bold-line frame.

Next, the FBI processing is executed. Since the overdrive (OD) processing is applied to both of the first display data and the second display data in this embodiment, in the FBI processing of this embodiment, as indicated by the brightness cross-sectional profile shown in FIG. 3J, the waving phenomenon is not generated whereby the moving image performance can be improved. In the brightness cross-sectional profile shown in FIG. 3G, the distance is taken on an axis of abscissa D and the brightness is taken on an axis of ordinate B.

Hereinafter, the FBI processing of this embodiment is briefly explained.

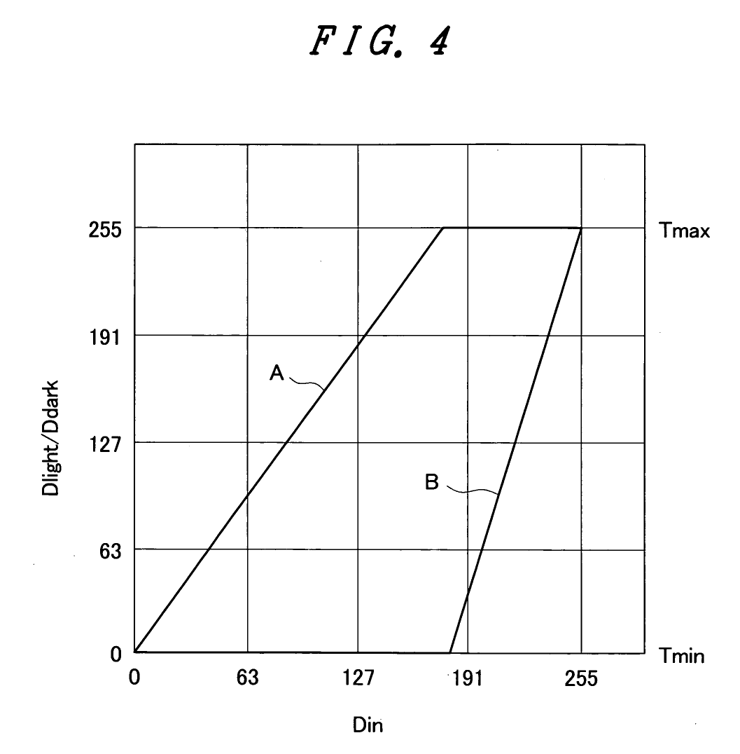

FIG. 4 is a view showing the conversion characteristic from the input display data into the display data for bright frame (Dlight) and the conversion characteristic from the input display data into the display data for dark frame (Ddark), wherein the input display data (Din) is taken on an axis of abscissa, and the display data for bright frame (Dlight) and the display data for dark frame (Ddark) are taken on an axis of ordinate.

In this embodiment, the frame in which an image is displayed based on the display data to which the conversion characteristic indicated by A in FIG. 4 is applied is referred to as the bright frame, and the frame in which an image is displayed based on the display data to which the conversion characteristic indicated by B in FIG. 4 is applied is referred to as the dark frame. Further, in general, the liquid crystal display panel changes the static brightness T corresponding to a liquid crystal applied voltage V, and the static brightness T exhibits the minimum brightness Tmin and the maximum brightness Tmax.

The conversion algorism of this embodiment realizes the naked-eye brightness corresponding to the input display data in accordance with the bright frame and the dark frame and, at the same time, is established on conditions that the dark frame acquires the dynamic brightness as close as possible to the minimum brightness Tmin of the liquid crystal display panel and that the static brightness when the input display data is at the brightest 256 gray scale is substantially equal to the maximum brightness Tmax.

The smaller the dynamic brightness in the dark frame or the larger a range in which the dynamic brightness in the dark frame is small, the moving image blurring can be reduced. Accordingly, it is preferable that the brightness in the dark frame assumes the minimum brightness Tmin. However, the brightness in the dark frame may assume the brightness slightly higher than the minimum brightness Tmin. The range within which the dynamic brightness in the dark frame assumes the minimum brightness Tmin is a range from 0 gray scale to a gray scale of the input display data corresponding to the naked-eye brightness acquired by setting the dynamic brightness in the bright frame to the maximum brightness Tmax and the dynamic brightness in the dark frame to the minimum brightness Tmin. However, the range within which the dynamic brightness in the dark frame assumes the minimum brightness Tmin may be a range from 0 gray scale to a gray scale slightly smaller than the gray scale of the input display data corresponding to the naked-eye brightness acquired by setting the dynamic brightness in the bright frame to the maximum brightness Tmax and the dynamic brightness in the dark frame to the minimum brightness Tmin.

Further, the range within which the dynamic brightness in the bright frame assumes the maximum brightness Tmax is a range from the gray scale of the input display data corresponding to the naked-eye brightness acquired by setting the dynamic brightness in the bright frame to the maximum brightness Tmax and the dynamic brightness in the dark frame to the minimum brightness Tmin to the 256 gray scale. However, the range within which the dynamic brightness in the bright frame assumes the maximum brightness Tmax may be a range from a gray scale slightly smaller than the gray scale of the input display data corresponding to the naked-eye brightness acquired by setting the dynamic brightness in the bright frame to the maximum brightness Tmax and the dynamic brightness in the dark frame to the minimum brightness Tmin to the 256 gray scale.

In the display of an image, it is desirable that the brightness difference between the respective gray scales is set to a substantially equal interval as viewed with naked eyes of human. In general, when the brightness is expressed by 256 gray scales, the relationship between the display data D for driving liquid crystal and the static brightness T is designed to satisfy a so-called gamma curve expressed by a following formula (1).

(static brightness T)=(liquid crystal drive data D/255) \hat{γ} (1)

Here, gamma is 2.2 in general and hence, the explanation is made by setting gamma as γ=2.2.

Assuming both of a rising time Tr and a falling time Tf of the liquid crystal display panel 1 as 0, the display brightness can be approximated by a following formula (2).

display brightness=(static brightness T in bright frame)/2+(static brightness T in dark frame)/2 (2)

By indicating the input display data as Din, the display data in bright frame as Dlight, and the display data in dark frame as Ddark, assuming gamma as γ=2.2, a following formula (3) is established from the formula (1) and the formula (2), and the characteristic indicated by a solid line in FIG. 4 is acquired.

Dlight=2̂(1/2.2)*Din, wherein 2̂(1/2.2)*Din<255

Dlight=255, wherein 2̂(1/2.2)*Din≧255

Ddark=0, wherein 2̂(1/2.2)*Din<255

Ddark=255*(2*Din/255)̂2-1), wherein 2̂(1/2.2)*Din≧255

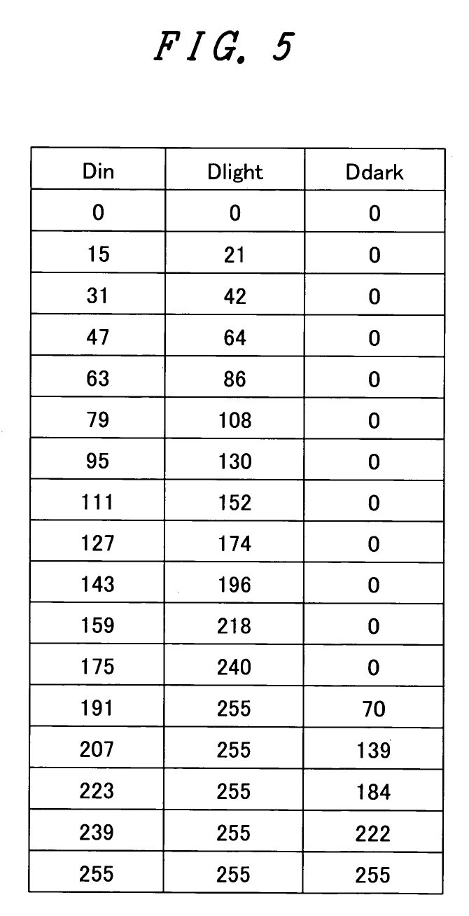

Here, the look-up tables 216, 217 are not always necessary to have table values corresponding to all input display data (Din), and it is sufficient for the look-up tables 216, 217 to have the table values which sufficiently satisfy linearity among gray scales. For example, as shown in FIG. 5, a table for every 16 gray scales is prepared, and the conversion display data may be generated by interpolation such as linear interpolation with respect to gray scales between these tables. Due to such look-up-table constitution, sizes of the conversion tables can be made small.

Here, although the above-mentioned explanation is made with respect to the embodiment to which the present invention is applied to the liquid crystal display module, the present invention is also applicable to a hold-type display device such as an organic EL (Electro Luminescence) display or an LCOS (Liquid Crystal On Silicon) display.

Although the invention made by inventors of the present invention has been specifically explained in conjunction with the embodiment heretofore, it is needless to say that the present invention is not limited to the above-mentioned embodiment and various modifications are conceivable without departing from the gist of the present invention.

What is claimed is:

1. A display device comprising:
a display panel having a plurality of sub pixels;
a signal generation circuit for generating a control signal for driving the display panel in response to an inputted signal from the external system; and
a driver for outputting a video voltage corresponding to the display data to the respective sub pixels, wherein
the display data inputted from the external system is constituted of normal display data and interpolation display data inserted between the normal display data and generated based on the normal display data by interpolation,
the signal generation circuit includes an overdrive circuit for applying overdrive processing to the normal display data and the interpolation display data inputted from the external system, and a gray scale conversion circuit for converting the gradation of display data applied overdrive by the overdrive circuit,
assuming two continuous frame periods as one unit and assuming the display data inputted from the external system within the two continuous frame periods as first display data and second display data, when the display data inputted from the external system is of an intermediate gray scale, gray scale based on the second display data after conversion is set lower than gray scale based on the first display data after conversion.

2. A display device according to claim 1, wherein the driver outputs a first video voltage corresponding to the first display data after conversion to the respective sub pixels in the first frame period out of the two continuous frame periods, and outputs a second video voltage corresponding to the second display data after conversion to the respective sub pixels in the second frame period out of the two continuous frame periods.

3. A display device according to claim 1, wherein the display device includes a frame memory which holds display data of the present frame and display data of the frame immediately before the present frame, and
the overdrive circuit determines a correction quantity of the overdrive processing which is applied to the first display data and the second display data based on the difference between the display data of the present frame and the display data of the frame immediately before the present frame.

4. A display device according to claim 1, wherein the first display data is the normal display data, and the second display data is the interpolation display data.

5. A display device according to claim 1, wherein each sub pixel displays one gray scale required by the external system by displaying two gray scales in the two continuous frame periods,
when a gray scale required by the external system is included in a low-gray-scale side of an intermediate gray scale arranged between a maximum gray scale and a minimum gray scale, one of two gray scales within the two continuous frame periods assumes a minimum gray scale and another of the two gray scales within the two continuous frame periods is changed corresponding to the gray scale required by the external system, and
when the gray scale required by the external system is included in a high-gray-scale side of the intermediate gray scale, one of two gray scales within the two continuous frame periods is changed corresponding to the gray scale required by the external system and another of the two gray scales within the two continuous frame periods assumes the maximum gray scale.

6. A display device according to claim 5, wherein when the gray scale required by the external system is the maximum gray scale, both of the two gray scales within the two continuous frame periods assume the maximum gray scale.

7. A display device according to claim 5, wherein a boundary between the low-gray-scale side and the high-gray-scale side of the gray scale required by the external system is a gray scale obtained by setting one of the two gray scales within the two continuous frame periods as the minimum gray scale and another of the two gray scales as the maximum gray scale.

8. A display device including a display panel which has a plurality of sub pixels and displaying an image on the display panel by setting an interval of 120 Hz as one frame period, the display device comprising:
an overdrive circuit for correcting image information of each frame based on the image information of the frame immediately before the present frame; and
a brightness conversion circuit which forms a bright frame and a dark frame alternately with time by performing processing for forming the bright frame by increasing brightness of the image information of each frame and processing for forming the dark frame by decreasing the brightness of the image information of each frame.

9. A display device according to claim 8, wherein the image information displayed on the display panel is processed by the brightness conversion circuit after being processed by the overdrive circuit and, thereafter, is displayed on the display panel.

10. A display device according to claim 8, wherein the brightness conversion circuit includes a bright-frame-use look-up table which stores data for converting the inputted image information into bright-frame-use information therein and a dark-frame-use look-up table which stores data for converting the inputted image information into dark-frame-use information therein.
